(19) United States
(12) Patent Application Publication
(10) Pub. No.: US 2005/0120344 A1
(43) Pub. Date: Jun. 2, 2005

(54) Optimal component installation

(75) Inventors: Kwasi Addo Asare, Durham, NC (US); Attila Barta, Toronto (CA); Richard D. Huddleston, Newtonville, MA (US); Daniel Everett Jemiolo, Pascoag, RI (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/725,612

(22) Filed: Dec. 2, 2003

(51) Int. Cl. G06F 9/445

(52) U.S. Cl. 717/174

(57) ABSTRACT

A system for installing application components in a target platform can include a component installation engine configured to install application components and respective dependencies over a component distribution system. A script processor can be coupled to the engine and programmed to parse target specific installation scripts to identify both a listing of dependencies for the application components and at least one specified relationship between the application components and individual ones of the respective dependencies. Finally, a requirements verification processor can be programmed to enforce both target platform requirements for installing the application components and the at least one specified relationship prior to installing the application components.

### BACKGROUND OF THE INVENTION

1. Statement of the Technical Field

The present invention relates to the field of application component distribution, and more particularly to the target platform neutral management of application component requirements during the installation of an application component.

2. Description of the Related Art

Though often overlooked, application installation is a prerequisite to interacting with a software application. Specifically, in most circumstances, an application can be properly executed only subsequent to the completion of a successful installation process. At the minimum, a typical software application installation requires a transfer of files to the file structure of a computing system, and the configuration of the computing system to particularly interact with the software application. Ordinarily, the configuration of the computing system includes the addition or modification of registry settings, the addition or modification of entries to one or more initialization files, or both.

In the context of an application installation meant to upgrade the components of an application, oftentimes, simply replacing application out-dated versions of application components with newer versions of components will not alone suffice as a complete application upgrade. Rather, in an era of code re-use, shared libraries, and interdependent program objects, replacing a single application component can have a dramatic effect upon other separate, but independent applications. Common disastrous consequences include altered and now incompatible application programming interfaces (APIs), re-positioned application objects, and removed application objects. In all cases, an application dependency can be broken simply by upgrading the application components of another, unrelated application.

Whereas application component upgrades can be problematic generally, in an autonomic system, the problem can be particularly acute. For the uninitiated, autonomic computing systems self-regulate, self-repair and respond to changing conditions, without requiring any conscious effort on the part of the computing system operator. To that end, the computing system itself can bear the responsibility of coping with its own complexity. The crux of autonomic computing relates to eight principal characteristics:

I. The system must “know itself” and include those system components which also possess a system identify.

II. The system must be able to configure and reconfigure itself under varying and unpredictable conditions.

III. The system must never settle for the status quo and the system must always look for ways to optimize its workings.

IV. The system must be self-healing and capable of recovering from routine and extraordinary events that might cause some of its parts to malfunction.

V. The system must be an expert in self-protection.

VI. The system must know its environment and the context surrounding its activity, and act accordingly.

VII. The system must adhere to open standards.

VIII. The system must anticipate the optimized resources needed while keeping its complexity hidden from the user.

Thus, in keeping with the principles of autonomic computing, the installation of application components must not only account for the seamless installation and configuration of the application components, but also the impact of the installation upon existing applications in the target platform. Moreover, it can be important that dependencies required for the nominal operation of the application components exist within the target platform, or can be accessed from the target platform. Finally, it can be critical that the infrastructure provided by the target platform, including its computing resources, meets the resource requirements of the application components. Hence, it will be of paramount concern to the autonomic system that the target platform itself will not become “broken” in consequence of the installation of the application components.

Presently, several application upgrade strategies exist. One such well-known strategy includes the venerable “ReadMe” file. In this strategy, software developers provide a list, typically as standard prose, of components in the application which are to be installed, the required pre-requisite components and any resource requirements to be provided by the target platform. Subsequently, during installation, an application administrator can peruse the contents of the list to determine the nature of the component installation. As it will be recognized by one skilled in the art, however, the creation and use of a conventional ReadMe file can be both tedious and unreliable.

It will also be well understood by those skilled artisans that automated methods exist at least to remediate the tedium associated with the conventional ReadMe file. Specifically, various programming tools have been developed through which application component dependencies can be identified among system elements. Prior to any installation effort, the programming tool can be executed so as to determine the risk of undertaking the application installation. Still, this process lacks the granularity necessary to definitively assess the changing nature of dependencies. Moreover, modern automated methods are target platform specific. As a result, modern automated methods remain product level solutions which are ill-suited for the “write once run anywhere” nature of modern enterprise computing.

### SUMMARY OF THE INVENTION

The present invention addresses the deficiencies of the art in respect to application component distribution and provides a novel and non-obvious method, system and apparatus for installing an application component from a platform neutral semantic model for the application component. In accordance with the present invention, a component installation method can include identifying target platform requirements for installation a subject application component within a target specific installation script, and further identifying a listing of dependencies for the subject application and at least one specified relationship between the subject application and individual ones of the dependencies. Notably, the at least one specified relationship can be a relationship selected from the group consisting of a containment relationship, a usage relationship, a contradictory relationship and an equivalence relationship.

Both the target platform requirements and the specified relationship can be enforced prior to installing the subject application component. In this regard, the installation can be aborted where either one of the target platform requirements and the at least one specified relationship cannot be enforced. In a preferred embodiment, the enforcing step can include determining whether all required ones of the dependencies can be accessed in the target platform. For each required one of the dependencies which cannot be accessed in the target platform, the required one of the dependencies can be located and installed in the target platform. Moreover, the determining step can include the step of querying a registry of installed components in the target platform to identify components which have been installed in the target platform.

A system for installing application components in a target platform can include a component installation engine configured to install application components and respective dependencies over a component distribution system. A script processor can be coupled to the engine and programmed to parse target specific installation scripts to identify both a listing of dependencies for the application components and at least one specified relationship between the application components and individual ones of the respective dependencies. Finally, a requirements verification processor can be programmed to enforce both target platform requirements for installing the application components and the at least one specified relationship prior to installing the application components.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a script generation engine disposed within an application component distribution system;

FIG. 2 is a block diagram illustrating a system for installing an application component according to a target specific installation script produced by the engine of FIG. 1; and,

FIG. 3 is a flow chart illustrating a process for optimally installing an application component to a target platform according to the system of FIG. 2.

### DETAILED DESCRIPTION OF THE PREFERRED EMBODIMENTS

The present invention is a system, method and apparatus for optimally installing an application component in a target platform based upon a platform neutral specification of the installation process for the application component. In accordance with the present invention, a target specific installation script can be generated from a platform neutral model of the application component and its dependent components. The target specific installation script further can specify a minimum requisite configuration for the target platform. Upon installation, first the target platform can be inspected to ensure that the resources available within the target platform meet the minimum requisite configuration. Subsequently, the target platform can be inspected to ensure that the required dependencies can be accessed in the target platform and that the dependency relationships specified within the target specific installation script are enforced.

In this regard, the dependency relationships can include not only containment relationships in which one component can depend upon the operation of another, but also usage relationships in which one component can be functional only in the presence of another component, contradictory relationships in which one component cannot be functional in the presence of another component, and equivalence relationships in which one component can be substituted for another component. In any case, where a dependency is lacking for a containment or usage relationship, the dependency can be located and loaded excepting where a suitable equivalent component can be substituted for the missing component. Only where one or more of the specified dependency relationships or the minimum requisite configuration cannot be satisfied can the installation of the application component fail.

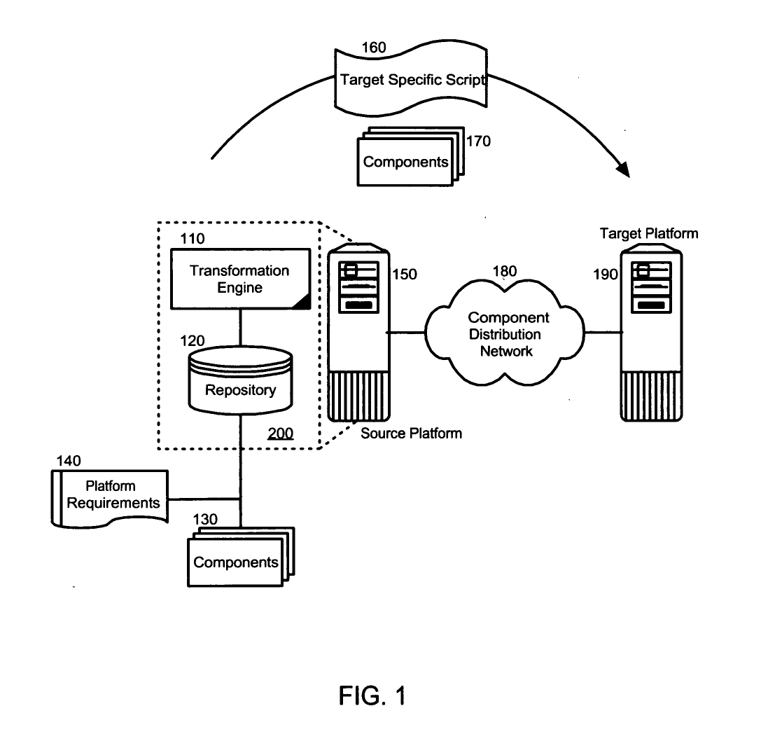

FIG. 1 is a schematic illustration of a script generation engine disposed within an application component distribution system. The system can include a script generation engine 200 coupled to a source platform 150 configured for distributing subject application components 130 to individual target platform environments 190 over a component distribution network 180. The target platform environments 190 can range from an individual application hosting environment to a distributed and coordinated network of application hosting environments, to a cluster of application hosting environments. Additionally, the component distribution network 180 can range from a simple Intranet to a complex data communications network.

The source platform 150 can be coupled to the components 130. The components can include application logic compartmentalized into one or more objects which can operate within an execution environment such as a virtual machine. As it will be recognized by the skilled artisan, each of the components 130, can have specific resource requirements within the target platform 190, including a minimum amount of accessible memory, fixed storage and network bandwidth, to name a few. Additionally, each of the components 130 can depend upon the operation of one or more other components 130. For example, a Web application server can depend upon the operation of a database server, and a mail server can depend upon the availability of a data communications stack.

Inasmuch as the components 130 can have both a set of target platform requirements and component dependencies, target platform requirements 140 can be recorded for each of the components 130 and stored within a repository 120 communicatively associated with the script generation engine 200. Preferably, the target platform requirements 140 can include deployment target requirements. The component dependencies, by comparison, can include a specification of the relationship between the components, including their respective ordering, any pre-requisite components required for the operation of other ones of the components, whether certain components are to be excluded from operation during the operation of other components, and equivalence among components such that one component can be interchanged for another.

Through the communicative association between the script generation engine 200 and the repository 120, the repository 120 can be accessed by a script generation process (not shown) in the script generation engine 200 based upon a specification of components. Within the repository 120, a model of functional dependencies between components 130 also can be stored. Preferably, the model along with the requirements can be formatted within a markup language with components specified according to their respective network addressing scheme. In this way, one familiar with the schema for the markup language document can readily parse the document to identify the hierarchical model of interdependent application components and their respective target platform requirements.

Significantly, a transformation engine 110 further can be communicatively associated with the script generation engine 200 and coupled to the repository 120. The transformation engine 110 can resolve mappings between the dependency relationships specified in the repository 120 and actual instructions (not shown) for installing a corresponding one of the components 130 in the target platform 190. Preferably, the transformation engine can generate a markup language formatted target specific script 160 for a selected set of components 170 to be installed in the target platform 190. The script 160 can include specific instructions for deploying the components 170 in the target platform 190. The instructions not only can identify pre-requisite minimum resources within the target platform 190, but also the script can identify dependencies required for the operation of the components 170, interchangeable ones of those dependencies, contradictions between the components 170 and already existing components in the target platform 190, and limitations on usage of one or more of the components 170.

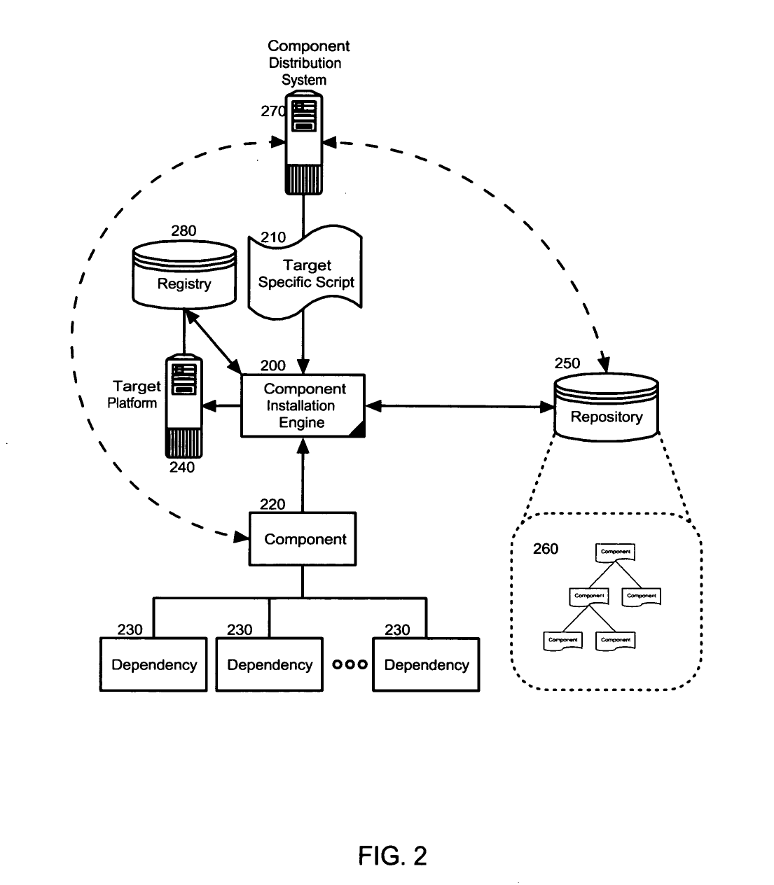

FIG. 2 is a block diagram illustrating a system for installing an application component according to a target specific installation script produced by the engine of FIG. 1. Referring now to FIG. 2, a component installation engine 200 can process the target specific script 210 produced in behalf of the component distribution system 270. In particular, the component installation engine 200 can parse the target specific script 210 first to identify a set of target platform requirements, such as minimum available memory, fixed storage space, minimum processor resources, etc. To that end, the component installation engine 200 can inspect the configuration of the target platform 240. Where the configuration of the target platform 240 cannot satisfy the requisite configuration specified within the target specific script 210, the installation can abort.

Otherwise, the component installation engine 200 can identify within the target specific script 210 a listing of dependencies 230 whose functional operation within target platform 240 will be required for the nominal operation of the application component 220. In support of this function, the component installation engine 200 can query the repository 250 to recall the semantic model 260 for the interdependent hierarchy of components 230 required by the installation of the application component 220. The model 260 can be compared to a registry 280 of installed components to determine whether the required dependencies 230 have been installed in the target platform 240, or whether any one or more missing ones of the dependencies 230 can be located and installed.

Notably, to the extent that updates or patches to already installed ones of the dependencies 230 can be discovered in the repository 250, the updates and patches automatically can be applied to the already installed dependencies 230. Of course, so much would be the case only where a network connection is present. Where no network connection is present, retrieving patches from a network repository will not be possible. In any event, where the required interdependencies or suitable equivalent dependencies can be installed in the order prescribed by target specific script 210, the application component 220 can be installed to the target platform 240 and the installation can be written to the registry 280. Otherwise, the installation process can be deemed to have failed and the installation of the application component 220 can be aborted.

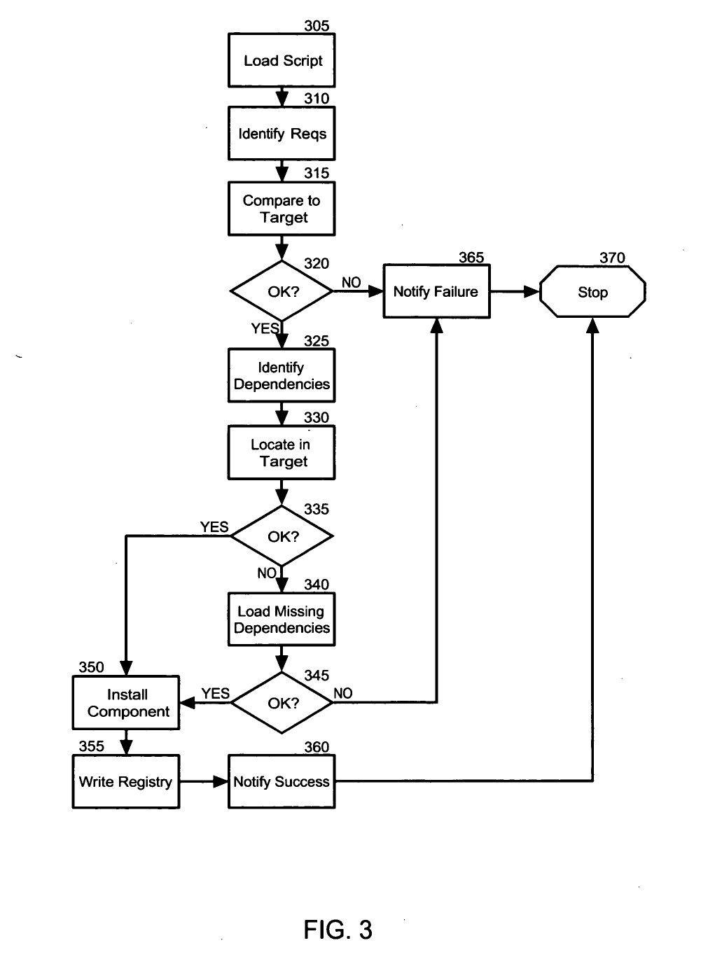

In more particular illustration of the operation of the system of FIG. 2, FIG. 3 is a flow chart illustrating a process for optimally installing an application component to a target platform according to the system of FIG. 2. Beginning in block 305 the target specific installation script for an application component can be loaded. In block 310, the platform requirements for the application component and its dependencies can be identified. In block 315, the target platform requirements can be compared to the available resources of the target platform. If in block 320, the target platform cannot provide the requisite level of computing resources, in block 365 a failure notification can be generated and in block 370 the process can end. Otherwise, the process can continue in blocks 325 through 365.

If in block 320 the target platform can provide the requisite level of computing resources, in block 325 the dependencies for the application component can be identified. In this regard, not only can directly specified dependencies be identified, but also all sub-dependencies can be identified by traversing the model of the dependency hierarchy for the application component. Specifically, for each dependency, it can be determined if sub-dependencies exist. Similarly, for each sub-dependency, it can be determined if further sub-dependencies exist and so forth. By traversing the hierarchy of dependencies, a comprehensive listing of required dependencies can be generated.

In block 330, all required dependencies (whether usage based, containment based, or equivalence based) can be located in the target platform. Additionally, any components which are noted within the target specific script to conflict with the installation of the application component can be confirmed to not to have been installed in the target platform. If in block 335 the required dependency relationship of the target specific script does not comport with the state of the target platform, any missing dependencies can be loaded in block 340. If in block 345 the required dependency relationship of the target specific script still does not comport with the state of the target platform, in block 365 a failure notification can be generated and the process can end in block 370. Otherwise, in block 350 the application component can be installed and in block 355 the installation of the components can be written to the registry. Finally, in block 360 a success notification can be generated and the process can terminate in block 370.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A component installation method comprising the steps of:
identifying target platform requirements for installation a subject application component within a target specific installation script;
further identifying a listing of dependencies for said subject application and at least one specified relationship between said subject application and individual ones of said dependencies;
enforcing both said target platform requirements and said at least one specified relationship prior to installing said subject application component; and,
aborting said installation where either one of said target platform requirements and said at least one specified relationship cannot be enforced.

2. The method of claim 1, wherein said further identifying step comprises the step of further identifying a listing of dependencies for said subject application and at least one specified relationship between said subject application and individual ones of said dependencies, wherein said at least one specified relationship is a relationship selected from the group consisting of a containment relationship, a usage relationship, a contradictory relationship and an equivalence relationship.

3. The method of claim 1, wherein said enforcing step comprises the steps of:
determining whether all required ones of said dependencies can be accessed in said target platform; and,
for each required one of said dependencies which cannot be accessed in said target platform, locating and installing said required one of said dependencies in said target platform.

4. The method of claim 3, wherein said determining step comprises the step of querying a registry of installed components in said target platform to identify components which have been installed in said target platform.

5. The method of claim 3, wherein said enforcing step further comprises the step of updating dated ones of said required ones of said dependencies which can be accessed in said target platform with updated versions of said required ones of said dependencies.

6. The method of claim 3, wherein said enforcing step further comprises the step of patching flawed ones of said required ones of said dependencies which can be accessed in said target platform with updated versions of said required ones of said dependencies.

7. A system for installing application components in a target platform, the system comprising:
a component installation engine configured to install application components and respective dependencies over a component distribution system;
a script processor coupled to said engine and programmed to parse target specific installation scripts to identify both a listing of dependencies for the application components and at least one specified relationship between the application components and individual ones of said respective dependencies; and,
a requirements verification processor programmed to enforce both target platform requirements for installing the application components and said at least one specified relationship prior to installing the application components.

8. The system of claim 7, wherein said at least one specified relationship comprises a relationship selected from the group consisting of a containment relationship, a usage relationship, a contradictory relationship and an equivalence relationship.

9. The system of claim 7, wherein said component installation engine further comprises a communicative coupling to a repository of updated ones of said dependencies.

10. A machine readable storage having stored thereon a computer program for component installation, the computer program comprising a routine set of instructions which when executed by the machine cause the machine to perform the steps of:
identifying target platform requirements for installation a subject application component within a target specific installation script;
further identifying a listing of dependencies for said subject application and at least one specified relationship between said subject application and individual ones of said dependencies;
enforcing both said target platform requirements and said at least one specified relationship prior to installing said subject application component; and,
aborting said installation where either one of said target platform requirements and said at least one specified relationship cannot be enforced.

11. The machine readable storage of claim 10, wherein said further identifying step comprises the step of further identifying a listing of dependencies for said subject application and at least one specified relationship between said subject application and individual ones of said dependencies, wherein said at least one specified relationship is a relationship selected from the group consisting of a containment relationship, a usage relationship, a contradictory relationship and an equivalence relationship.

12. The machine readable storage of claim 10, wherein said enforcing step comprises the steps of:
determining whether all required ones of said dependencies can be accessed in said target platform; and,
for each required one of said dependencies which cannot be access in said target platform, locating and installing said required one of said dependencies in said target platform.

13. The machine readable storage of claim 12, wherein said determining step comprises the step of querying a registry of installed components in said target platform to identify components which have been installed in said target platform.

14. The machine readable storage of claim 12, wherein said enforcing step further comprises the step of updating dated ones of said required ones of said dependencies which can be accessed in said target platform with updated versions of said required ones of said dependencies.

15. The machine readable storage of claim 12, wherein said enforcing step further comprises the step of patching flawed ones of said required ones of said dependencies which can be accessed in said target platform with updated versions of said required ones of said dependencies.
